(19) United States
(12) Patent Application Publication
(10) Pub. No.: US 2005/0003837 A1
(43) Pub. Date: Jan. 6, 2005

(54) System and method for SMS text routing

(76) Inventors: David S. Midkiff, Kirkland, WA (US); Thomas J. Cast, Redmond, WA (US)

Correspondence Address: DOCKET CLERK, P.O. BOX 802432, DALLAS, TX, 75380, US

(21) Appl. No.: 10/840,810

(22) Filed: May 7, 2004

Related U.S. Application Data
(60) Provisional application No. 60/469,576, filed on May 8, 2003.

(51) Int. Cl. H04Q 7/20

(52) U.S. Cl. 455/466

(57) ABSTRACT

A system and method is that enables a user to enter a single address or number into a mobile device and thereby request many types of information based on simple keywords. In one embodiment, the information is requested using a mobile-originated SMS message, and the user thereafter receives the requested information by a mobile terminated SMS message.

### CROSS-REFERENCE TO OTHER APPLICATION

This application claims priority from U.S. Provisional Patent Application 60/469,576, filed May 8, 2003, which is hereby incorporated by reference.

### TECHNICAL FIELD OF THE INVENTION

The present invention is directed, in general, to messaging and, more particularly, relates to text messaging on mobile devices.

### BACKGROUND OF THE INVENTION

Mobile communication systems include a variety of services and functions beyond simple direct voice communication. Mobile communication service providers offer a variety of text messaging methods. Many of the services require that the text be input via the keypad of a mobile communication device such as a wireless telephone.

Most mobile device keypads are small. As a result, some users find it difficult to enter long text messages via the keypad. Current methods of routing text messages require input of lengthy text messages which can be difficult for some users.

There is a need for a system that overcomes the above problems, as well as providing additional benefits.

There is, therefore, a need in the art for a system, method, and computer program product for improved routing and delivery of text messages.

### SUMMARY OF THE INVENTION

To address the above-discussed deficiencies of the prior art, it is a primary object of the present invention to provide a system, method, and computer program product for improved text messaging.

According to one embodiment of the invention, a system and method is provided for a user to enter a single address or number into a mobile device and thereby request many types of information based on simple keywords. In one embodiment, the information is requested using a mobile-originated SMS message, and the user thereafter receives the requested information by a mobile-terminated SMS message.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a network architecture for the SGTR in accordance with a preferred embodiment;

FIG. 2 depicts a block diagram of an SGTR architecture in accordance with a preferred embodiment;

FIG. 3 depicts a block diagram of an integration of a routing system in accordance with the preferred embodiment with existing SMPP gateways and local directors;

FIG. 4 depicts a message flow diagram for an MO message send to text service ESME, in accordance with a preferred embodiment of the present invention

FIG. 5 depicts a message flow diagram for the case where the SGTR receives a MO message for a text routing service that contains an unrecognized keyword

FIG. 6 depicts a message flow diagram for the case where the destination_address parameter in the MO message received at the SGTR is not associated with a text routing service;

FIG. 7 depicts a block diagram of a keyword definition in accordance with a preferred embodiment of the present invention; and

FIG. 8 depicts a flowchart of a MO message processing process in accordance with the preferred embodiment.

### DETAILED DESCRIPTION OF THE INVENTION

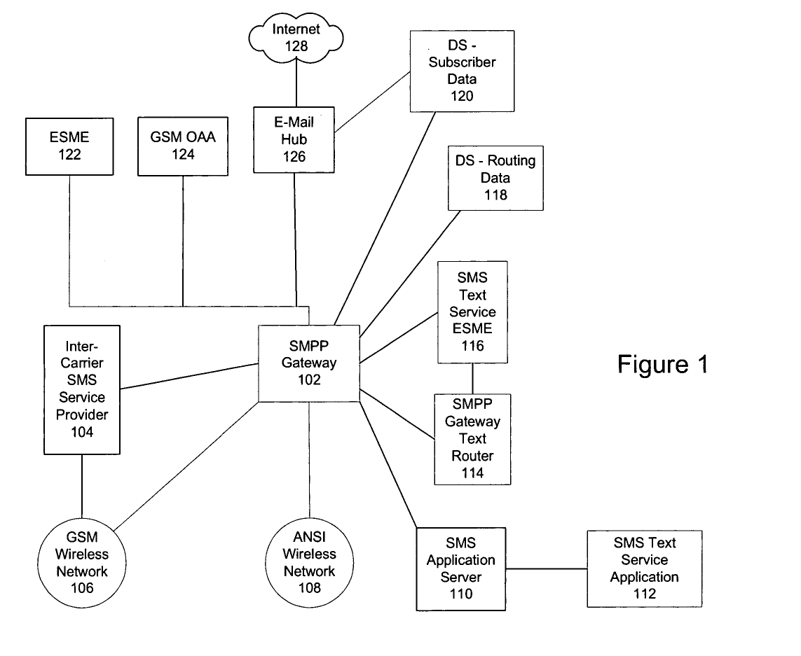

FIGS. 1 through 8, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

Definitions: Following are short definitions of some of the technical terms and acronyms which are used in the present application. Some terms are particular to the disclosed embodiments, and others are well known to those of skill in the art. Those of ordinary skill will recognize whether the context requires a different meaning of an otherwise common term. Additional definitions can be found in the standard technical dictionaries and journals.

| | |
|---|---|
| CMT | Cellular Messaging Teleservice |
| DA | Destination Address |
| DAV | Directory Address Verification |
| DN | Directory Number |
| DS | Directory Server |
| ESME | External Short Message Entity |
| ESN | Electronic Serial Number |
| TID | Teleservice Identifier |
| MC | Message Center |
| MDN | Mobile Directory Number |
| MO | Mobile Originated |
| MS | Mobile Station, a phone |
| MSC | Mobile Switching Center |
| MT | Mobile Terminated |
| OATS | Over The Air Activation Teleservice |
| OTAP | Over the Air Activation and Programming |
| PDU | Protocol Data Unit |
| RIP | Replace If Present |
| SG | SMPP Gateway |
| SGTR | SMPP Text Router |
| SMDPP | Short Message Delivery Point to Point |
| SMPP | Short Message Peer to Peer |
| SMSREQ | SMS Request |
| SG | SMPP Gateway |

According to one embodiment of the invention, a system and method is provided for a user to enter a single address or number into a mobile device and thereby request many types of information based on simple keywords. In one embodiment, the information is requested using a mobile-originated SMS message, and the user thereafter receives the requested information by a mobile-terminated SMS message.

The SMPP Gateway Text Router (SGTR) routes Short Message Service (SMS) text messages using Short Message Point to Point (SMPP) protocol based on text keywords within the text message. A subscriber can send a message to a destination address or number and request information. The SGTR analyzes the content of the message and routes the message to a server that will respond with the information requested by the user. For example, the user sends a message to 1234 with text of ‘weather forecast Seattle’. The message is routed to the SGTR based on the 1234 address. The SGTR ‘reads’ the message text and then routes the message to a server that can send the weather forecast for Seattle to the user. The server sends the requested information to the user's phone. The SGTR analyzes the message for any keywords and routes the message to a service based on those values. If no keyword is found in the message the SGTR sends a message back to the user describing the valid keywords and how to use the service.

Any message that contains appropriate text keywords can be routed to applications that return some type of information or take some type of action based on the user's request.

SGTR provides routing capabilities necessary for introduction of SMS based information request services. A subscriber can request information using a Mobile Originated (MO) SMS message. The network routes the message to the application providing this service based on the destination address (DA) of the message, which is, in the preferred embodiment, a four-digit short code, and the content of the text message. Of course, the DA can be of various lengths, not necessarily limited to 4 digits. The text message contains a keyword and information requested. The keyword may be one or more consecutive words, but is preferably limited to two words. The keyword identifies the application to which the text message should be routed. The SGTR maintains routing rules that associate a DA short code and text keyword to destination ESME.

Some examples of possible information request text messages are shown below. Keywords are shown in UPPERCASE for purposes of illustration, but preferably need not be actually entered in uppercase.

| | |
|---|---|
| WEATHER | Request weather forecast for a |
| FORECAST | city |
| Seattle | |
| WEATHER NOW | Request current weather for a |
| Seattle | city |
| STOCK AWE | Request stock quote (AWE here |
| | is used as an argument, not as |
| | a keyword) |
| SPORTS | Request baseball scores |
| baseball | |

FIG. 1 depicts a block diagram of a network architecture for the SGTR in accordance with a preferred embodiment.

This figure shows a GSM (Global System for Mobile Communications) network 106 and an ANSI (American National Standards Institute) network 108; those of skill in the art will recognize that other networks can also be used. Note that components of networks 106 and 108 are omitted for clarity of illustration. The components, known to those of skill in the art, include message centers, mobile service centers, specific wireless networks and compatible mobile terminals, number portability databases (NPDB), and others.

Networks 106 and 108 communicate with SMPP Gateway (SG) 102; also, inter-carrier SMS service provider 104 can be used to communicated between network 106 and SG 102 if they are not in direct communication for SMS purposes. Unless otherwise noted, the communications described herein with relation to the SG can be by any known means, and are preferably SMPP (TCP/IP) communications. In particuale signaling system 7 (SS7)/ANSI-41 communications can be used between an NPDB and SG 102.

The SG 102 also communicates with SMS application server 110, and through it to SMS text service application 112.

The SG 102 also communicates with email hub 126, GMS over-air activation 126 and ESME 122. Internet 128 is accessible to SG 102 via email hub 126. Subscriber data DS 120 and routing data DS 118 are accessed, preferably using a lightweight directory access protocol, by SG 102 and email hub 126.

SG 102 also communicates with SMS text service ESME 116 and SGTR 114. ESME 116 and SGTR 114 also communicate with each other. The SG 102 communicates with SMS application server 110 to access specific SMS text service applications 112.

The following description provides an example of the use of this service. A subscriber in either a GSM (Global System for Mobile Communications) network 106 or ANSI (American National Standards Institute) network 108 sends an MO message with a four-digit short code DA (for example, “1234”) and message content of “WEATHER Seattle”. The MO message is received at the MC of a network.

The MC the message to the SG 102. The SG 102 analyzes the DA and determines it is a short code that is to be routed to the SGTR 114. The SG 102 routes the message to the SGTR 104. The SGTR 104 analyzes the beginning of the text of the short message for a keyword. In this example the keyword is “WEATHER”. SGTR uses its routing rules to route the message to the text service ESME 116 providing the weather service. The text service ESME receives the message and determines the weather report for Seattle should be sent to the originating subscriber. The text service ESME formats the reply and sends it directly to the SG 102 for delivery to the subscriber.

While GSM and ANSI networks are described in the preferred embodiment, those of skill in the art recognize that the principles of the claimed invention can be applied to other communication networks.

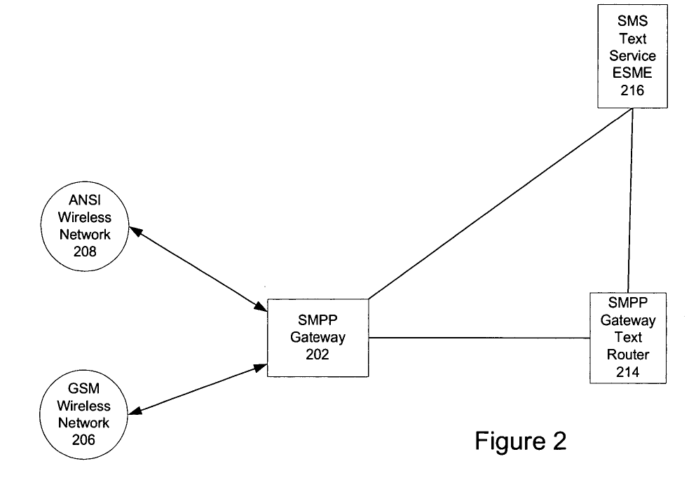

FIG. 2 depicts a block diagram of an SGTR architecture in accordance with a preferred embodiment. Here, SMPP gateway 202 is connected to communicate with ANSI wireless network 208 and GSM wireless network 206. Preferably the MT routing and MO short-code routing is performed using techniques known to those of skill in the art.

Mobile-originated text messages with an SMS text application short-code destination address received by SMPP gateway 202 are passed to SMPP gateway text router 214, using SMPP (TCP/IP) techniques. The SGTR processes and routes the message as described herein to the specific SMS text service application ESME 216 based on the message content. ESME 216 can then send an MT message containing an SMS text response to the MS via SMPP gateway 202.

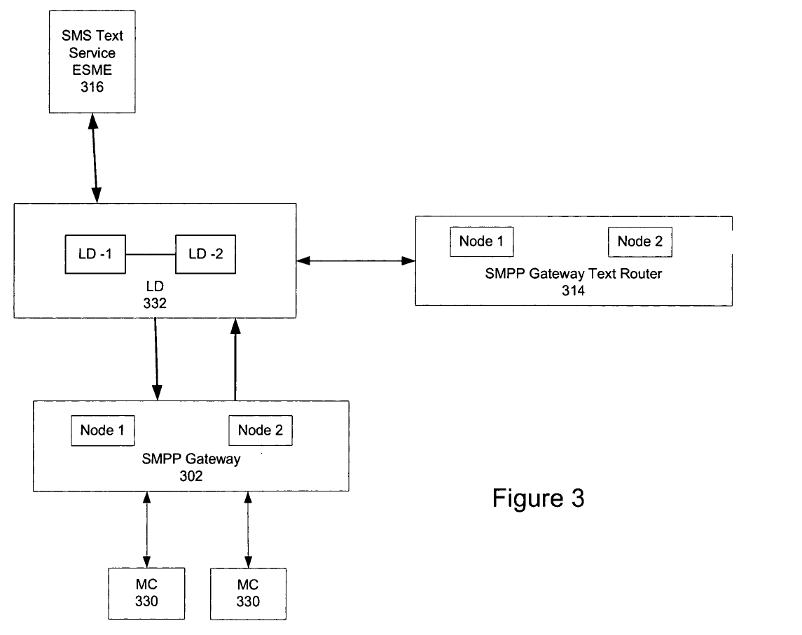

The text service ESME composes a MT reply short message containing the requested information and sends it directly to the SG. Routing the MT reply through SGTR provides no additional value. The SGTR is integrated with the existing SG and local directors (LD) as shown in FIG. 3.

FIG. 3 depicts a block diagram of an integration of a routing system in accordance with the preferred embodiment with existing SMPP gateways and local directors.

At start up the following binds occur:
1. SGTR 314 binds to SG 302 as ESME receiver for MO traffic. Bind is through the LD 332.
2. SGTR 314 binds to SG 302 as ESME transmitter for MT traffic (help text messages). Bind is through the LD 332.
3. Text EMSE 316 binds to SGTR 314 as receiver through LD 332. This connection delivers MO request messages to the text ESME 316.
4. Text ESME 316 binds to SG 302 as transmitter though LD 332. The text ESME 316 sends MT response messages to the SG 302 for routing to the appropriate MC 330.

Binds may be done to logical names.

As illustrated in this figures, the SGTR, SG, and LD can each have multiple nodes.

The SGTR will provide text routing services based on the DA and keyword within the text message. Routing is based on the unique combination of DA and text keyword. For example a message with a DA of 1234 and text of ‘STOCK awe’ routes to ESME A, a message with a DA of 2345 and text of ‘STOCK awe’ routes to ESME B.

If the text keyword in the received message cannot be mapped to an ESME, the text routing service can be configured to respond in two ways: Return an ‘invalid destination address’ command status to the MC, or a send pre-configured text message to the originating subscriber. The message contains help text describing how to use the service.

This could also be used as a general help function. For example if a message contains the text ‘help’ the SGTR responds with a message that describes how to use the service, for example, “valid key words are Stock, Weather, etc.”

The message flows associated with SMS text routing are described in the following sections.

MO Message to Text Service ESME

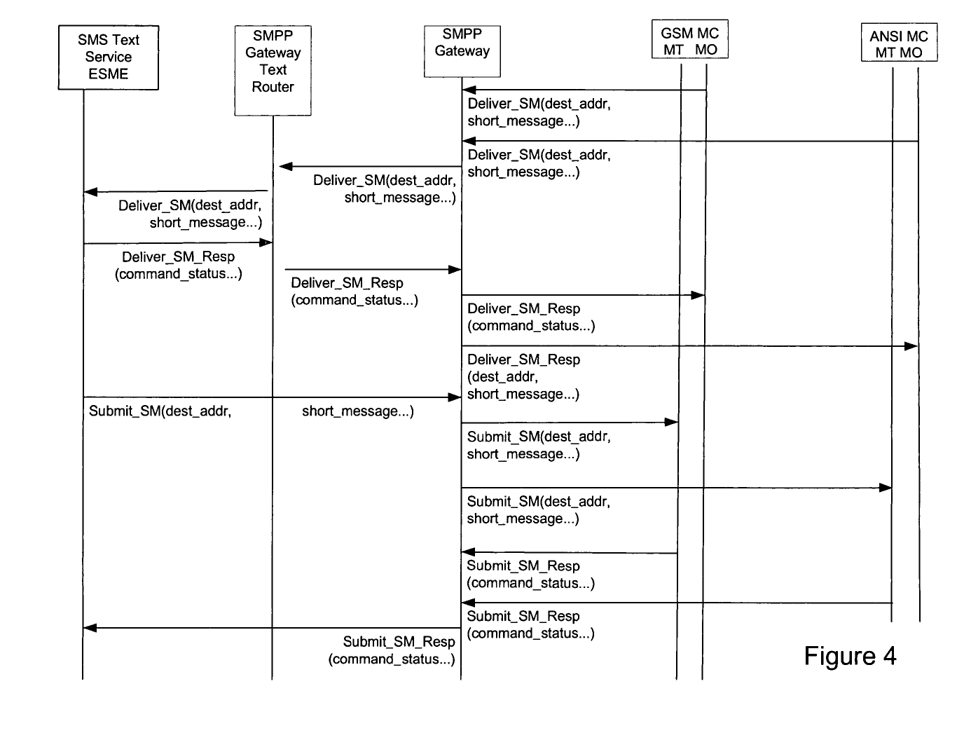

FIG. 4 depicts a message flow diagram for an MO message send to text service ESME, in accordance with a preferred embodiment of the present invention. In this Figure, a MO message is sent to a text service ESME. The text service ESME responds with the requested information.
a. GSM MC sends Deliver_SM containing text request SMS message to SG for further routing. Deliver_SM destination_address is a four digit short code
b. Alternately the message could originate at an ANSI MC.
c. SG routes Deliver_SM to SGTR based on short code value in destination_address parameter.
d. SGTR receives Deliver_SM and determines that destination_address is associated with a valid text routing service. Message in short_message parameter contains a valid keyword for the text routing service. SG routes message to destination text service ESME.
e. Text service ESME sends Deliver_SM_Resp to SGTR
f. SGTR sends Deliver_SM_Resp to SG
g. SG sends Deliver_SM_Resp to GSM MC
h. Alternately, SG sends Deliver_SM_Resp to ANSI MC
i. Text service ESME processes information request in received Deliver_SM and responds with requested information. Text service ESME sends Submit_SM containing requested information to SG. Destination_address is MDN of MS.
j. SG routes Submit_SM to GSM MC for delivery in wireless network using existing procedures.
k. Alternately SG routes Submit_SM to ANSI MC for delivery in wireless network using existing procedures.
l. GSM MC responds with Submit_SM_Resp to SG
m. Alternately ANSI MC responds with Submit_SM_Resp to SG.
n. SG routes Submit_SM_Resp to text service ESME.

MO Message with Invalid Keyword

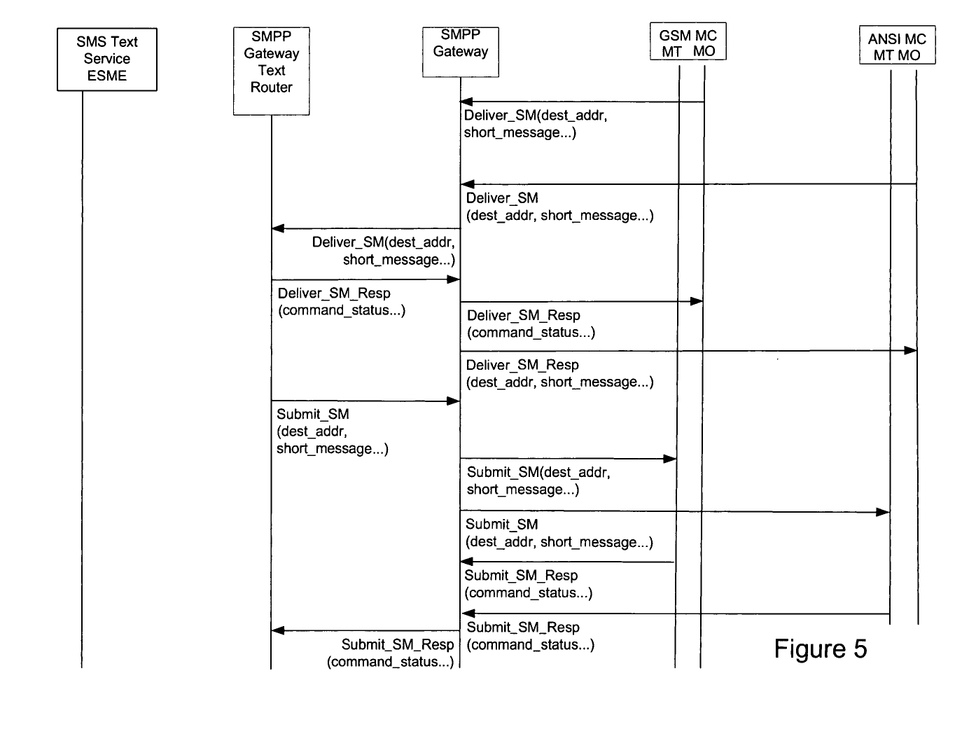

FIG. 5 depicts a message flow diagram for the case where the SGTR receives a MO message for a text routing service that contains an unrecognized keyword.
a. GSM MC sends Deliver_SM containing text request SMS message to SG for further routing. Deliver_SM destination_address is a four digit short code
b. Alternately the message could originate at an ANSI MC.
c. SG routes Deliver_SM to SGTR based on short code value in destination_address parameter.
d. SGTR receives Deliver_SM and determines that destination_address is associated with a valid text routing service. Message in short_message parameter contains an unrecognized keyword for the text routing service.
e. SGTR sends Deliver_SM_Resp to SG
f. SG sends Deliver_SM_Resp to GSM MC
g. Alternately, SG sends Deliver_SM_Resp to ANSI MC
h. Text routing service at SGTR is configured to send help text message to originating subscriber when an unrecognized keyword is received. SGTR sends Submit_SM containing help text information to SG
i. SG routes Submit_SM to GSM MC for delivery in wireless network using existing procedures.
j. Alternately SG routes Submit_SM to ANSI MC for delivery in wireless network using existing procedures.
k. GSM MC responds with Submit_SM_Resp to SG.
l. Alternately ANSI MC responds with Submit_SM_Resp to SG.
m. SG routes Submit_SM_Resp to SGTR.

MO Message with Invalid Destination Address

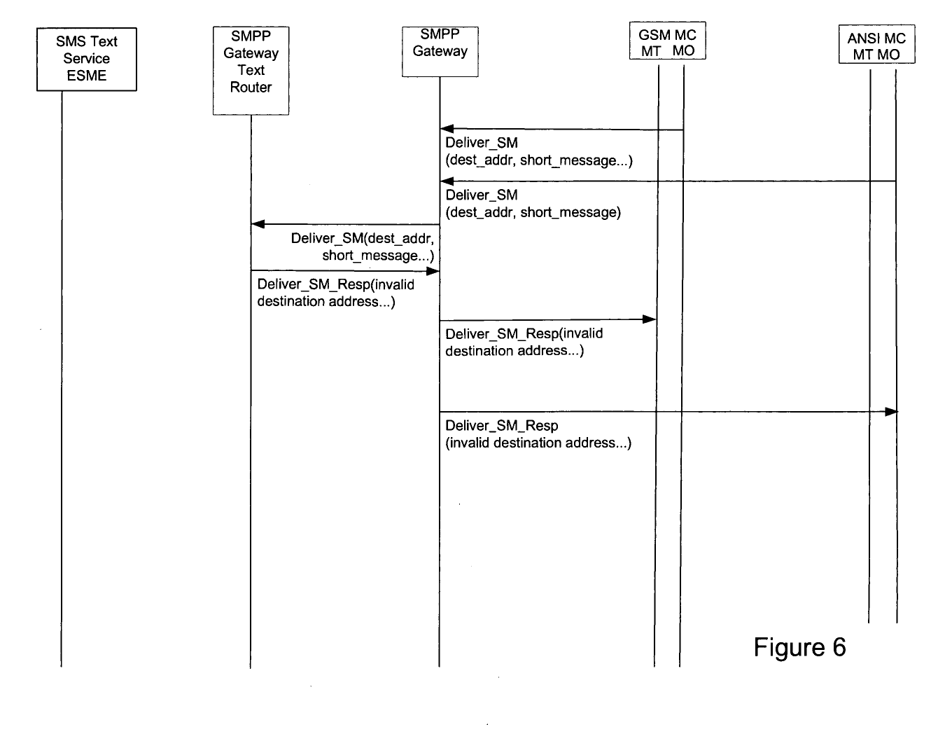

FIG. 6 depicts a message flow diagram for the case where the destination_address parameter in the MO message received at the SGTR is not associated with a text routing service.
a. GSM MC sends Deliver_SM containing text request SMS message to SG for further routing. Deliver_SM destination_address is a four digit short code
b. Alternately the message could originate at an ANSI MC.
c. SG routes Deliver_SM to SGTR based on short code value in destination_address parameter.
d. SGTR receives Deliver_SM and determines that destination_address is not associated with a valid text routing service.
e. SGTR sends Deliver_SM_Resp to SG with command_status set to invalid destination address.
f. SG sends Deliver_SM_Resp to GSM MC.
g. Alternately SG sends Deliver_SM_Resp to ANSI MC.

Keyword Definition

The SMS request message is transported in the short_message parameter of the Deliver_SM PDU.

A keyword may be one or two words. If the keyword is two words they may be separated by one or more spaces. Keywords are case insensitive (although commonly shown herein as uppercase for illustrative purposes). Keywords are always the first one or two words of the message.

The maximum length message that may be received, in the preferred embodiment, is 160 characters.

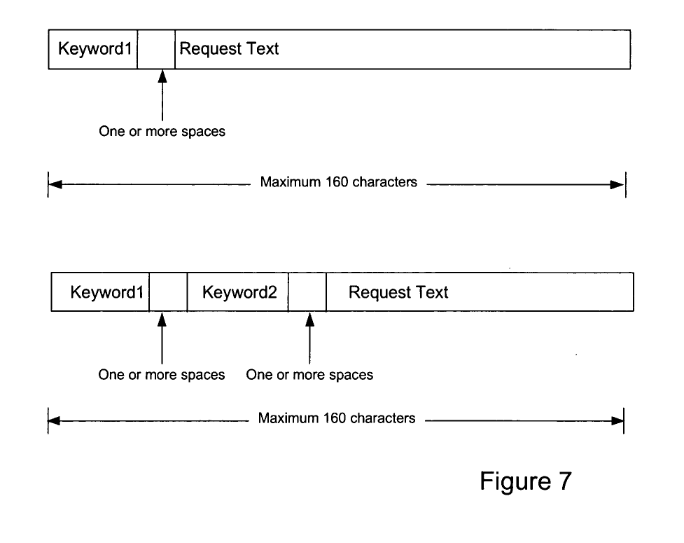

FIG. 7 depicts a block diagram of a keyword definition in accordance with a preferred embodiment of the present invention.

A keyword is preferably one or two words separated by one or more spaces, as shown. The keyword is preferably the first one or two consecutive words of the short_message parameter. Keywords are preferably case insensitive.

Text Routing Service

A text routing service defines the relationship between a destination address, text keywords, and destination ESME providing the requested service. The destination address is unique among all text routers (TRs). SGTR provides a message text to ESME routing capability. The message text routing capability is based on the content of the text within the short_message and destination_address parameters of the Deliver_SM PDU.

The SGTR of a preferred embodiment provides, at a minimum, the configurable parameters for each text routing service, as shown in the following table:

| Parameter | Description |
|---|---|
| Text routing service name | The name of the text |
| | routing service |
| Destination address | Four to eight digit short |
| | code destination address |
| | that applies to the text |
| | routing service. |
| Keyword not found action | Defines what action to |
| | take if the received text |
| | message does not contain a |
| | recognized keyword. |
| | 1. Reject the message. |
| | 2. Send help text |
| | message to the |
| | subscriber. |
| Help text message | Help text message to send |
| | if received message does |
| | not contain a recognized |
| | keyword and keyword not |
| | found action is set to |
| | send help text message. |
| | Maximum length is 160 |
| | characters. |
| MT service type for | The MT service type used |
| sending help text message | to send the message to the |
| | SG. |
| Text routing service | Available or unavailable. |
| state | |
| Keyword to ESME | A list of keywords and the |
| association | ESME destinations. |
| | Messages containing this |
| | keyword are routed to the |
| | ESME. Each keyword has |
| | one ESME destination. |

The destination address for a text routing service is preferably unique. It is preferably not possible to provision more than one text routing service with the same destination address.

The state of text routing service is configurable as available or unavailable. The SGTR is preferably capable of supporting a minimum of 100 text routing services. The SGTR is preferably capable of supporting a minimum of 250 keywords for each text routing service.

MO Message Logic

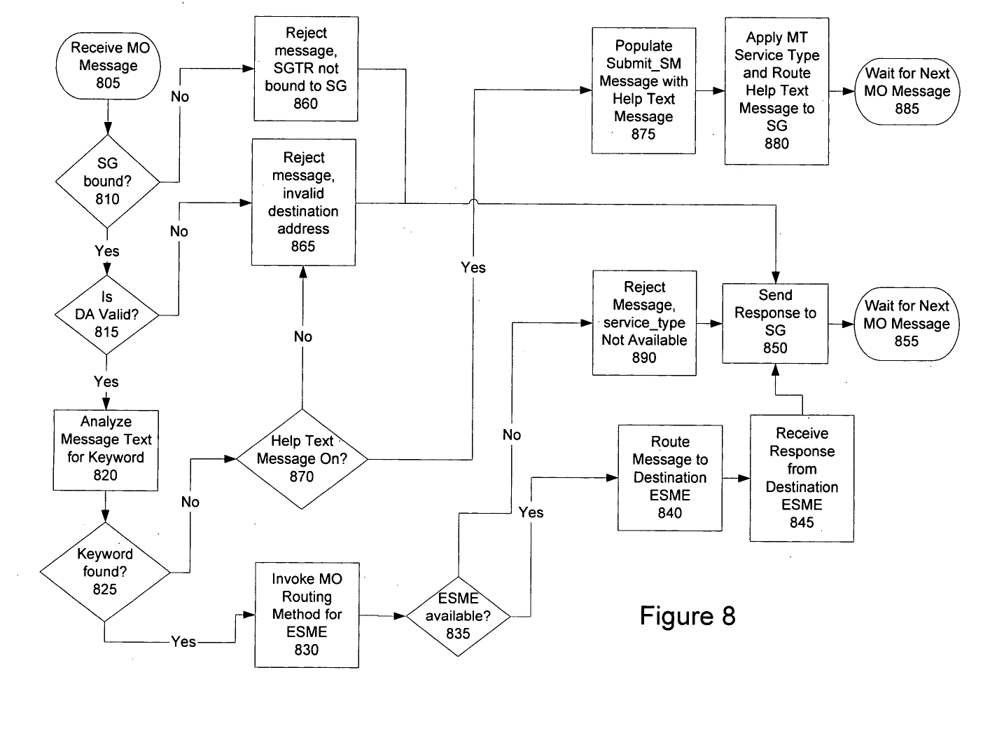

FIG. 8 depicts a flowchart of a MO message processing process in accordance with the preferred embodiment.

Here, when a mobile-originated (MO) SMS message is received (step 805), the system first determines if the SMPP gateway (SG) is bound (step 805). If not, the message is rejected (step 860) since the SGTR is not bound to the SG. This response is sent to the SG (step 850), and the system will await the next ME message (step 855).

If the SG is bound, then the system next determines if the destination address is valid (step 815). If not, the message is rejected (step 865) as having an invalid destination address or keyword. This response is sent to the SG (step 850), and the system will await the next ME message (step 855).

If the DA is valid, then the system analyzes the message text for a keyword (step 820). If no keyword is found, the system checks to see if the help-text-message option is activated (step 870). If not, the message is rejected (step 865) as having an invalid destination address or keyword. This response is sent to the SG (step 850), and the system will await the next ME message (step 855). If the help-text-message option is activatied, the system will populate the submit_sm message with the appropriate help text message (step 875). The system then applies the MT service type and routes the help text message to the SG (step 880). The system waits for the next MO message (step 855).

If a keyword is found in step 825, the system will invoke the MO routing method for the ESME (step 830), as described herein, and will determine if an ESME is available (step 835). If not, the system will reject the message as service_type not available (step 890. This response is sent to the SG (step 850), and the system will await the next ME message (step 855).

If the ESME is available, the system will route the message to the destination ESME (step 840), and receive a response from the destination ESME (step 845). This response is sent to the SG (step 850), and the system will await the next ME message (step 855).

When the SGTR receives a Deliver_SM PDU and the destination_address is not associated with a text routing service the SGTR shall return a command status of ‘invalid destination address’ in the Deliver_SM_Resp PDU.

If the SGTR receives a Deliver_SM PDU and the destination_address is not associated with a text routing service the SGTR it shall issue an alarm. The alarm shall contain, at a minimum, the destination_address and invalid destination address indication.

If the SGTR receives a Deliver_SM PDU and the destination_address is not associated with a text routing service the SGTR it shall log an event. The event shall contain, at a minimum, the destination_address and invalid destination address indication.

The only time the SGTR should receive an invalid DA is if the SG or SGTR is not provisioned correctly. Two scenarios could occur. The first is when the SG is configured to route a short code to the SGTR but the SGTR is not provisioned for that short code. The second scenario is if the SGTR is not provisioned for the short code sent from the SG.

When the SGTR receives a Deliver_SM PDU and the destination_address is associated with a text routing service the SGTR shall analyze the short_message parameter of the PDU for keywords defined for the text routing service. If a keyword is found the SGTR shall route the message to the ESME associated with the keyword.

If the destination ESME selected by the text routing service is not available the SGTR shall respond with a service type not available command_status in the Deliver_SM_Resp PDU.

The SGTR shall receive the Deliver_SM_Resp PDU from the destination ESME and subsequently send it to the originating SG unaltered.

When the SGTR receives a Deliver_SM PDU and the destination_address is associated with a text routing service the SGTR shall analyze the short_message parameter of the PDU for keywords defined for the text routing service. If a keyword is not found the SGTR shall take the action defined by the keyword not found action provisioned for the text routing service.

If a keyword is not found and the keyword not found action is set to reject the SGTR shall respond with an ‘invalid destination address’ command_status in the Deliver_SM_Resp PDU.

If a keyword is not found and the keyword not found action is set to send help message the SGTR shall respond with a Submit_SM PDU containing the help text message configured for the text routing service. The Submit_SM PDU is preferably populated as described herein.

If the text routing service has a state of unavailable the SGTR shall return a command status of ‘service type not available’ in the Deliver_SM_Resp PDU.

Composing Help Text Message

If the routing service is configured to send a help text message when it receives unrecognized keywords SGTR sends a MT message containing the help text to the SG for subsequent routing to the subscriber.

SGTR populates the MT message, Submit_SM, with pre-configured values for each parameter except for the short_message and destination_address parameters. The Submit_SM short_message parameter is populated with the help text configured for the text routing service. The destination_address of the Submit_SM is the source_address received in the Deliver_SM.

The parameters of the Submit_SM PDU containing the help text message is preferably configurable, except for the destination_address and short_message parameter.

There is preferably one Submit_SM PDU configuration for the SGTR.

The destination_address of the Submit_SM message is preferably mapped directly from the originating_address of the received Deliver_SM PDU.

The short_message parameter of the Submit_SM PDU containing the help text message shall contain the help text message defined for the text routing service.

The Submit_SM PDU containing the help text message is preferably routed according to MT service type for sending help text message provisioned for the text routing service.

Retries for Help Text Messages

When sending a MT message it is possible that the SG or destination MC may not be available. The normal procedure is to store these messages and retry sending them at a later time. In the case of the SGTR the only MT message sent is a help text message sent when a received message does not contain a recognized keyword. If the MT message cannot be routed to the SG or MC then it will be discarded at the SGTR. This eliminates the need to develop message storage and retry capabilities at the SGTR.

In normal operation it is unlikely that the SGTR will be receiving messages but unable to send them. This condition would occur if the SG has just failed or all of the MT MCs are out of service.

If the SGTR receives a command_status other than success when sending the Submit_SM PDU containing the help text message the SGTR shall discard the message.

If the SGTR discards a help text message it shall issue an alarm. The alarm shall contain, at a minimum, the text service name, failure to send help text indication, and command_status received.

If the SGTR discards a help text message it shall log an event. The event shall contain, at a minimum, the text service name, failure to send help text indication, and command_status received.

In one embodiment, the SGTR routes messages based on destination address and text keyword.

In the network architecture, the text External Short Message Entities, (ESME) submit Mobile Terminated (MT) messages directly to the SG. If text ESMEs require query, cancel, and replace capabilities these should generally be routed directly to the SG.

TXT-411, a text messaging-based directory assistance service for direct “text-access” to the White and Yellow Pages™ and more. AT&T Wireless' TXT-411 service offers customers the added convenience of having phone numbers, business locations, and driving directions delivered right to their wireless phone via text messaging. The listings or directions can then be stored on the phone and recalled at any time.

A text messaging user can simply send a text message with a directory assistance query to the abbreviated number, or short code, such as, for example, “2411.” A message will be delivered to the user shortly thereafter with the requested listing or information.

Directory assistance listings for individuals or businesses may be submitted using a specific name and location in the body of the text short message query. The system may be designed to recognize multiple entry formats when selecting a location including the city, ZIP code, airport code, phone number (for businesses only) or street address. For example, a customer interested in finding a phone listing for someone can simply type “last name <space > first name.location” (e.g. Smith Jane.Seattle) and send it to “2411.” To find information about a business they simply type “business name.location” (e.g. Acme Restaurant.New York) and send it to “2411.”

Keyword searching also allows for broader queries, when message originators do not know the name of an individual or business. For example, a customer looking for a pizza place in Redmond, Wash. can simply send a text message with the query, “pizza.Redmond” to the number “2411.” The system would then return a message that includes a restaurant name, phone number, address, and menu of additional options such as driving directions. The message will also indicate if more than one listing meets the description and gives them the option to view the next listing.

This approach allows a service to be developed where a user can request many types of information using a single number and set of keywords.

As a further specific example of a method to get text message directory assistance, a text message can be created by following these query formats, in accordance with a preferred embodiment of the present invention:
a. business.location
b. business name or yellow pages category (Restaurants). location (Flowers.Fort Lauderdale)
c. .lastname.location (.Anderson. Pittsburgh)
d. .lastname firstname.location
e. .lastname firstname

Location information for such a query can include:
a. City
b. Zip code
c. Airport Code
d. Phone number (for businesses only)
e. Street address

The user will then dial 2411 and send the message. He will receive a reply message with the first available listing corresponding to the query. Up to 10 listing will be available. The first will be indicated by (1/10) or the number of listings available (1/7, for example). If more are available, they will be grouped in sets of 10.

A menu will be included with options for using the information:
a. Reply with (A) to get additional information on the listing;
b. (N) to request the next listing;
c. (D) to get Driving Directions; Reply with (M) until you have enough information to get to your destination; and
d. (H) to get Help with TXT-411 instructions.

Those skilled in the art will recognize that, for simplicity and clarity, the full structure and operation of all data processing systems suitable for use with the present invention is not being depicted or described herein. Instead, only so much of a network system and mobile device as is unique to the present invention or necessary for an understanding of the present invention is depicted and described. The remainder of the construction and operation of these systems and devices can conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

For example, rather than the standard SMPP interface used in the preferred embodiment described herein, many other types of additional interfaces may be possible (ex. HTTP, XML, SOAP, etc.).

A typical mobile device capable of benefiting from the preferred embodiments would typically include a processor, a memory for storing instructions and/or data, and input/output devices including, but not limited to a keypad, touchscreen, microphone, and speaker. Further, the mobile device would include a transceiver coupled with a processor and with an antenna assembly for wireless communication.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A short text messaging method for routing short text messages, the method comprising:
transmitting a short text message from an short text messaging device of the originating user to a router;
analyzing the short text message;
routing the short text message to a recipient application based on keywords with the text message; and
transmitting a short text reply message to the short text messaging device of the originating user.

2. The method of claim 1 in which the router is a SMPP Gateway text router.

3. The method of claim 1 in which the recipient of the short text message is uniquely identified by the keywords within the short text message.

4. The method of claim 1 in which the messaging device of the originating user is a mobile telephone.

5. The method of claim 1 in which the keywords identify a recipient application and a user-specified argument.

6. A short text messaging method for routing short text messages, the method comprising:
receiving a short text message originating from a wireless messaging device;
analyzing the short text message;
routing the short text message to a recipient data processing system application based on keywords within the text message; and
sending a short text reply message, corresponding to the short text message, to be transmitted to the wireless messaging device.

7. The method of claim 6, wherein the wireless messaging device is a mobile telephone.

8. The method of claim 6, further comprising routing the short text message to a data processing system based on keywords within the text message.

9. The method of claim 6, wherein the router is a SMPP Gateway text router.

10. The method of claim 6, wherein the recipient of the short text message is uniquely identified by the keywords within the short text message.

11. The method of claim 6, wherein the keywords include a recipient data processing system application identifier and a user-specified argument.

12. A short text messaging system, comprising:
receiving means for receiving a short text message, the short text message originating from a wireless messaging device;
processing means for analyzing the short text message;
routing means for routing the short text message to a recipient data processing system application based on keywords within the text message; and
sending means for sending a short text reply message, corresponding to the short text message, to be transmitted to the wireless messaging device.

13. The system of claim 12, wherein the wireless messaging device is a mobile telephone.

14. The system of claim 12, further comprising means for routing the short text message to a data processing system based on keywords within the text message.

15. The system of claim 12, wherein the routing means is a SMPP Gateway text router.

16. A computer program product tangibly embodied in a machine-readable medium, the method comprising:
instructions for receiving a short text message originating from a wireless messaging device;
instructions for analyzing the short text message;
instructions for routing the short text message to a recipient data processing system application based on keywords within the text message; and
instructions for sending a short text reply message, corresponding to the short text message, to be transmitted to the wireless messaging device.

17. The computer program product of claim 16, wherein the wireless messaging device is a mobile telephone.

18. The computer program product of claim 16, further comprising instructions for routing the short text message to a data processing system based on keywords within the text message.

19. The computer program product of claim 16, wherein the recipient of the short text message is uniquely identified by the keywords within the short text message.

20. The computer program product of claim 16, wherein the keywords include a recipient data processing system application identifier and a user-specified argument.

21. In a short text messaging system of a communication network having a short message gateway that routes short text messages, the improvement comprising:
a short text messaging application, stored in a computer readable medium, that correlates a keyword within a short message with the address of an intended recipient application.
